(19) United States
(12) Patent Application Publication
(10) Pub. No.: US 2010/0245239 A1
(43) Pub. Date: Sep. 30, 2010

(54) PRESSURE SENSING CONTROLLER

(75) Inventor: Aaron B. Sternberg, Vancouver, WA (US)

Correspondence Address: STOEL RIVES LLP - PDX, 900 SW FIFTH AVENUE, SUITE 2600, PORTLAND, OR, 97204-1268, US

(73) Assignee: IPPASA, LLC, Vancouver, WA (US)

(21) Appl. No.: 12/731,876

(22) Filed: Mar. 25, 2010

Related U.S. Application Data
(60) Provisional application No. 61/163,141, filed on Mar. 25, 2009.

(51) Int. Cl. G09G 5/00

(52) U.S. Cl. 345/156

(57) ABSTRACT

Embodiments of a pressure sensing controller implement grip and pressure sensing, as well as standard input control actuation, to provide control input by a user. The disclosed grip and pressure sensing control can be implemented in hand-held game controllers, control devices for appliances, cellular telephones, and any other type of devices that require control input. In the case of an existing control device with predefined control output, user programming of input settings to define command extensions allows extended gripping and pressure control input to be combined within the capable existing control outputs of the device.

### RELATED APPLICATION

This application claims benefit of U.S. Provisional Patent Application No. 61/163,141, filed Mar. 25, 2009.

### TECHNICAL FIELD

The present disclosure relates to hand-held game controllers, as well as manual control input devices, cellular telephones, and appliance control devices typically held in a user's hand. The designs of typical game controllers limit control command input to actuation of specific buttons and joysticks. The technical field of this disclosure expands the ability of manual controllers to allow control command input from more than the standard input systems available on existing controllers. The overall control compatibility with all the existing input methodologies is maintained, while greater control and command input over and above their current limited capacities are enabled.

### BACKGROUND INFORMATION

Manual controllers for manipulating images or symbols on a visual display of a computing device or appliance include, for example, joysticks, game pads, steering wheels, guns, and mice for video games; remote control devices for television, DVD, VCR, stereophonic equipment, projectors, and other such electronic equipment; cellular telephones; and portable video game systems. The majority of these hand-held controllers rely on typical push-button contacts or joystick style inputs to actuate their control command outputs. With all of these controllers, the appliances being controlled have predefined inputs that are specific for their control command outputs to the unit that is being controlled. Typically, hand-held controllers are thus limited to the pressing or manipulation of commonplace joystick, joypad, thumbstick, and buttons found on most controllers. Often overlooked are other areas of capable input, such as 1) pressure, especially from palm areas of grip; 2) squeezing; and 3) hand-to-hand force sensing, which would be practicable when two hands are used with a controller held by two hands. An added ability of the controller to sense user-applied pressure from these unused areas of capable input is the basis of the embodiments disclosed.

### SUMMARY OF THE DISCLOSURE

In exemplary embodiments, a hand-held game controller has not only all of the standard typical input devices, but also areas designed into the controller that allow for pressure, torque, and gripping inputs. These additional input sensors and sensing areas, constructed into the shell of the controller, allow further output control in conjunction with existing output control commands of the controller.

A manual controller implemented with pressure-sensing sensor control actuators is capable of producing the same control commands as those of the original controller, as well as interpreting and adding pressure-sensing sensor inputs within the existing predefined output control command structure. In one embodiment, a programmable microprocessor unit (MPU) adapts the existing and predefined output control commands to respond to pressure-sensing sensor inputs. This eliminates a requirement for special programming of the computing device being controlled to interpret new commands from the pressure-sensing sensors.

An advantage of implementing pressure-sensing sensors in control command actuators is that they provide for the user realistic tactile sensation of the controls required for actuation in performing the activities simulated by the game the user is playing. Such control command devices facilitate user immersion in the environment of the particular game, thereby affording a more realistic experience for the user watching and at least partly controlling the action appearing on a display screen. Preferred embodiments configure pressure-sensing sensor inputs in regions or areas gripped by the user so that the user exerts more than just fingertip pressure to control game action. Controlling game action with multiple fingers with or without use of part of the palm of the user's hand introduces memory of the hand muscles that give the user a realistic feel of the game environment. This is especially true for embodiments in which the pressure-sensing areas are covered by foam or other resilient material that compresses and relaxes in response to different amounts of pressure exerted by the user during game play. For example, two-handed game play facilitates squeezing one hand to control acceleration and the other hand to control braking of a vehicle, thereby affording user immersion in a more realistic game experience.

Additional aspects and advantages will be apparent from the following detailed description of preferred embodiments, which precedes with reference to the accompanying drawings.

### BRIEF DESCRIPTION OF THE DRAWINGS

FIGS. 1 and 2 are exploded views of respective first and second embodiments of a prior art manual controller.

FIG. 3A is a side elevation view of an embodiment of a manual controller hand grip member with its surface area shell cover removed to show two elastomeric pressure-sensing sensor placements within a grip member surface shell area. FIGS. 3B and 3C are respective plan and end views of the shell cover shown in FIG. 3A.

FIG. 4A is a side elevation view of an embodiment of a manual controller hand grip member with its surface area shell cover removed to show six elastomeric pressure-sensing sensor placements within a grip member surface shell area. FIGS. 4B and 4C are respective plan and end views of the shell cover shown in FIG. 4A.

FIGS. 5A and 5B are side elevation views of an embodiment of a manual controller hand grip member with multiple surface area shell covers, respectively, installed to cover each of multiple grip member surface shell areas and removed to reveal elastomeric pressure sensor placement in each of the multiple grip member surface shell areas. FIGS. 5C and 5D are respective plan and end views of the shell cover shown in FIG. 5A.

FIG. 6A is a fragmentary pictorial drawing showing the typical positioning of a variable potentiometer sensor as used in conventional hand-held game controllers.

FIG. 6B is a fragmentary pictorial drawing showing the placement of a rubber or elastomeric pressure sensor as a substitute for the prior art potentiometer sensor shown in FIG. 6A.

FIGS. 7A and 7B are respective frontal and right-hand side isometric views of a conventional cellular telephone and its push-button controls. FIG. 7C is a right-hand side isometric view of the cellular telephone of FIGS. 7A and 7B along the side surfaces of which are placed pressure sensors that are usable for control input as a user holds the telephone.

FIGS. 8A and 8B are respective frontal and right-hand side isometric views of a conventional television set hand-held remote control module and its push-button controls. FIG. 8C is a right-hand side isometric view of the remote control module of FIGS. 8A and 8B along the side surfaces of which are placed pressure sensors that are usable for control input as a user holds the remote control module.

### DETAILED DESCRIPTION OF PREFERRED EMBODIMENTS

In one embodiment, the available additional pressure sensors built into a hand-held game controller are polled and sensed by a dedicated MPU that is also programmable by the user. In this embodiment, the sensors are assembled underneath segmented shell plates covering the grips of the controller. With this example, in this particular embodiment, a user programs the MPU to use the grip-pressure sensors as a speed control accelerator pedal, so that when the user is squeezing harder, the controller interprets the reduced resistance of that pressure sensor input as the accelerator input and produces as an output to the game unit the correct command sequence to control this action. This eliminates the requirement of having the user limit the action of one finger and frees the finger to perform other control functions. The typical types of pressure-sensing sensor can be, but are not limited to, capacitive sensing, rubber-based pressure sensing devices, and elastomeric pressure sensors, all of which are very familiar to skilled persons.

These sensors are placed under portions of the exterior shell areas of the hand-held controllers. A controller may have many or few of these shells designed into the exterior portions of the controller. The greater the number of sensors on the device, the more definitive is the resolution of detectable control input. In this embodiment, the pressure sensors lie underneath the exterior shell portions and detect pressure when it is applied. These sensors are polled by the MPU and interpreted accordingly. It is also possible to cover the shell portions with foam, rubber, gel, plastic, or similar material and still detect the pressure being applied. The pressure sensors mentioned can also be used on the common button and thumbstick/joystick type inputs available on these game controllers, giving a greater resolution to the pressure forces when applied, taking the place of the more crude or mechanical variable potentiometer devices now popular.

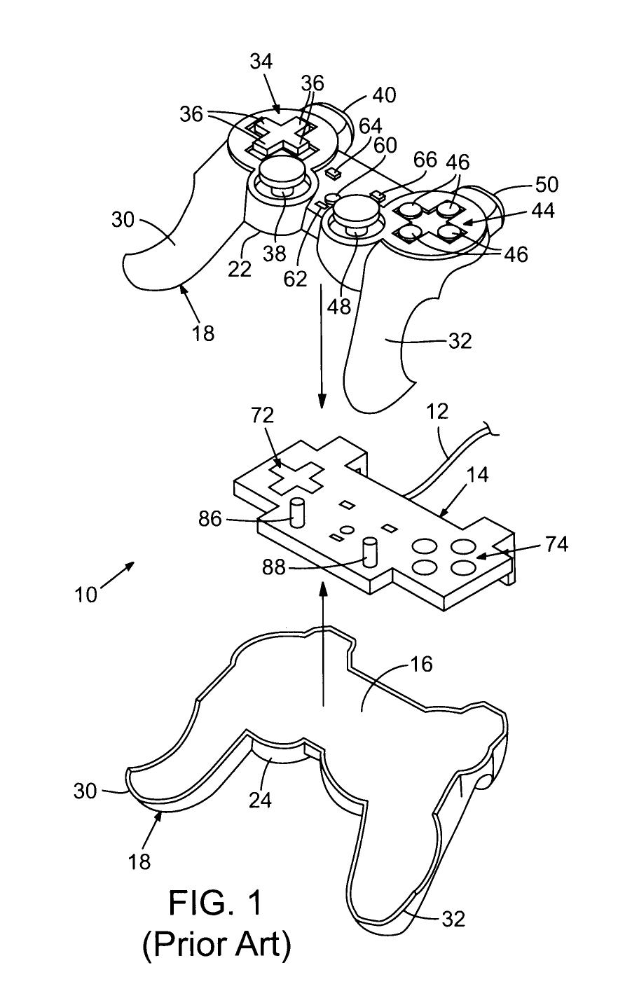

FIG. 1 is an exploded view of a first embodiment of a manual controller 10 that is detachably connected by a cable 12 to a computing device (not shown) for manipulating images or symbols on a display associated with the computing device. Although this embodiment is equipped with cable 12, manual controller 10 may also operate with a computing device through a wireless communication link. Manual controller 10 includes an internal electronics assembly 14 housed within an interior region 16 of a housing 18. In the first embodiment, manual controller 10 is assembled by placing internal electronics assembly 14 between an upper housing section 22 and a lower housing section 24. Upper and lower housing sections 22 and 24 are bonded together to form a casing for internal electronics assembly 14.

As shown in FIG. 1, housing 18 has a left-hand grip 30 and a right-hand grip 32 for two-handed gripping by a user. A left-side control pad 34 including four pressable control members 36, left-side analog stick control 38, and front left-side control button 40 are positioned for access by digits of the user's left hand; and a right-side control pad 44 including four control buttons 46, right-side analog stick control 48, and front right-side control button 50 are positioned for access by digits of the user's right hand. A mode selection switch 60, mode indicator 62, selection button 64, and start button 66 are positioned between hand grips 30 and 32. Skilled persons will appreciate that the above-described number of control actuators, control actuator layout pattern, and hand grip arrangement represent only one of numerous possible control actuator and hand grip configurations.

Internal electronics assembly 14 includes the actual electronic circuits, controls, and corresponding switch elements, including switch elements 72 and 74 for the respective control pads 34 and 44. Thus, the analog stick controls and buttons are actuated by user manipulation of the controls on the surface of housing 18.

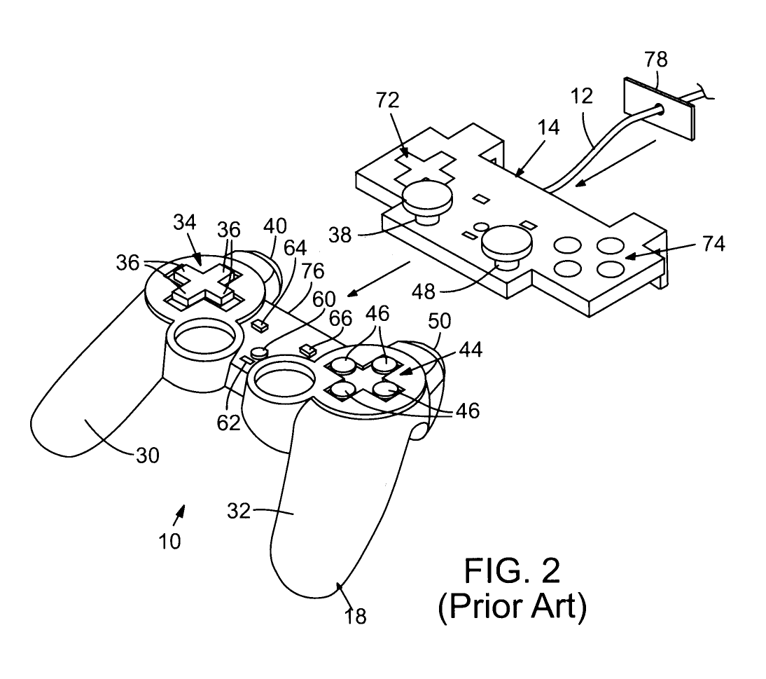

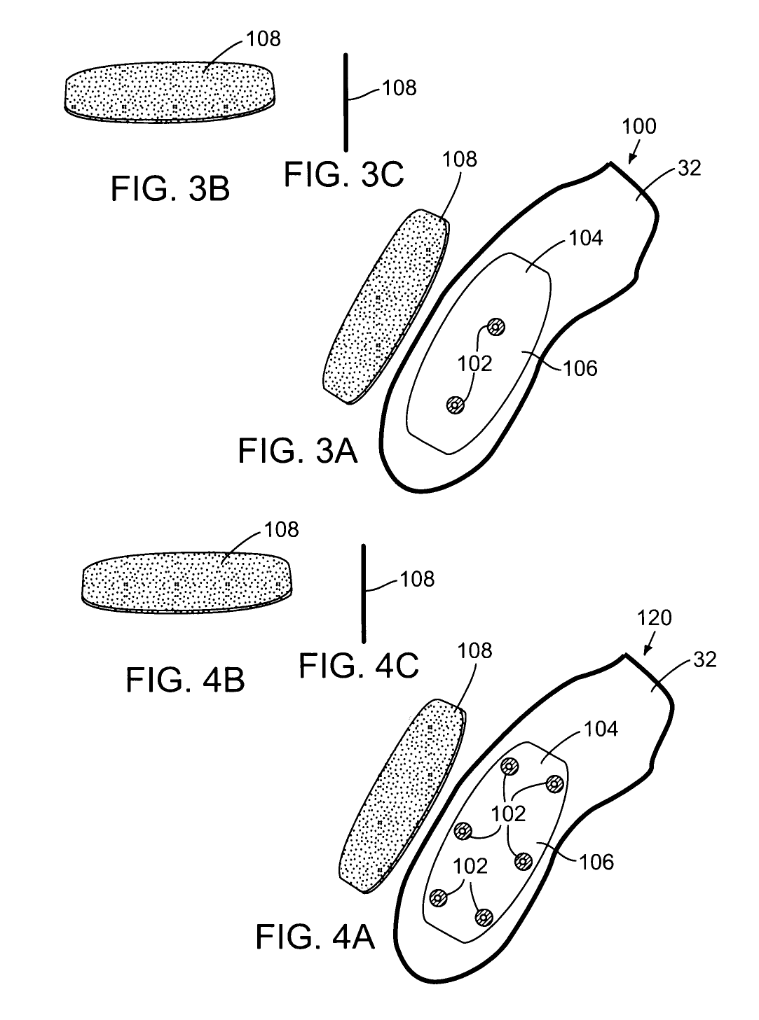

FIG. 3A shows an embodiment of an enhanced hand grip member 100 that includes hand grip 32 of FIGS. 1 and 2 in which is placed a set of two elastomeric pressure-sensing control actuators 102. Pressure-sensing control actuators 102 are placed in an area 104 on the lateral side of the outer surface of hand grip 32. Pressure-sensing control actuators 102 are seated in an inset 106, which fits in an opening in hand grip 32. FIGS. 3A, 3B, and 3C show different views of a shell member 108 covering pressure-sensing control actuators 102 to protect and transmit user-applied force to them. Shell member 108 is sized to fit around the perimeter of inset 106. Skilled persons will appreciate that manual controller 10 would typically be configured with another enhanced hand grip member 100 on hand grip 30 and could be configured with enhanced grip members 100 on the medial and lateral sides of either or both of hand grips 30 and 32.

The outputs of pressure-sensing control actuators 102 are scanned by a microprocessor unit (MPU), which is a component of internal electronics assembly 14. A level of sensor output from pressure-sensing control actuators 102 can be set to trigger a response consistent with the operational function or action being performed. Elastomeric and capacitive pressure-sensing sensors are very sensitive over a wide range of applied force and allow the user's fingers to remain free to provide other forms of control.

FIG. 4A shows an embodiment of an enhanced hand grip member 120 that is the same as enhanced hand grip member 100 except for the inclusion of a set of six pressure-sensing control actuators 102 arranged in an array forming an “H” pattern and seated in inset 106. FIGS. 4A, 4B, and 4C show different views of shell member 108 described above. Pressure-sensing control actuators 102, positioned underneath shell member 108 and pressed against hand grip 32 of housing 18, allow for greater resolution as to the actual types of forces the user exerts against them. With an ability to allow the scanning MPU to better sense torque, greater resolution is possible under conditions in which pressure is applied from one or both of a user's hands, even if manual controller 10 is being rotated and twisted. The better the sensing resolution, the better the MPU can interpret what forces are being applied to the array of sensors 102.

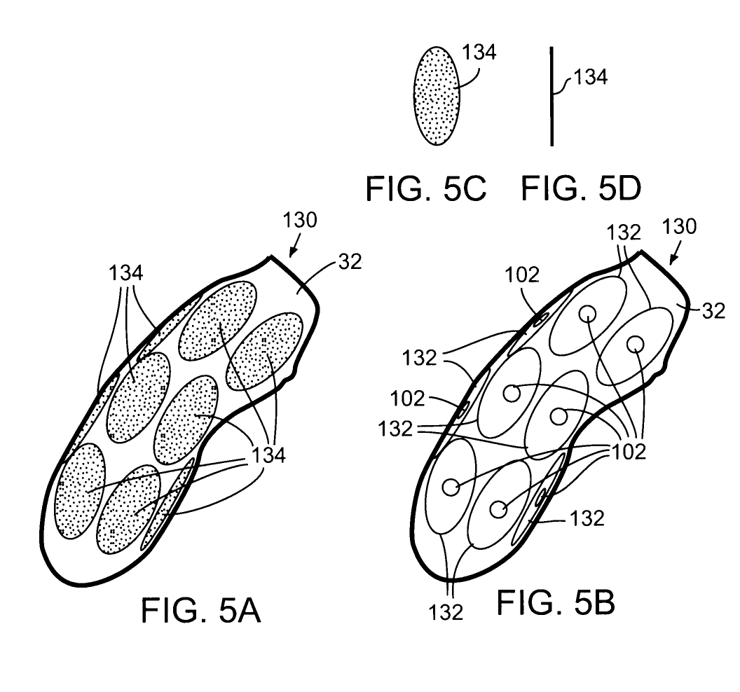

FIG. 5A shows an embodiment of an enhanced grip member 130 that represents nine unit sets of pressure-sensing control actuators 102 placed in nine different areas 132 of the entire grip surface of hand grip 32. FIG. 5B shows each one of nine shell members 134 covering a different one of pressure-sensing control actuators 102. Shell members 134 are smaller than shell member 108 of FIGS. 3A and 4A. The greater numbers of pressure-sensing control actuators 102 placed over the entire hand grip surface, in addition to the individual and smaller shell covers 134, provide an even more finely resolved determination of user-applied forces than that shown in FIG. 4A. Each of individual pressure-sensing control actuators 102 and shells 134, when MPU scanned, can provide specific inputs that are more accurately indicative of the actual forces applied by the user. Individual pressure-sensing control actuators can be imprinted with specific markings that allow on the grip surface inputs that do not break up the grip surface continuity and allow it to be smooth, with no protrusions like buttons or membrane bulges jutting out.

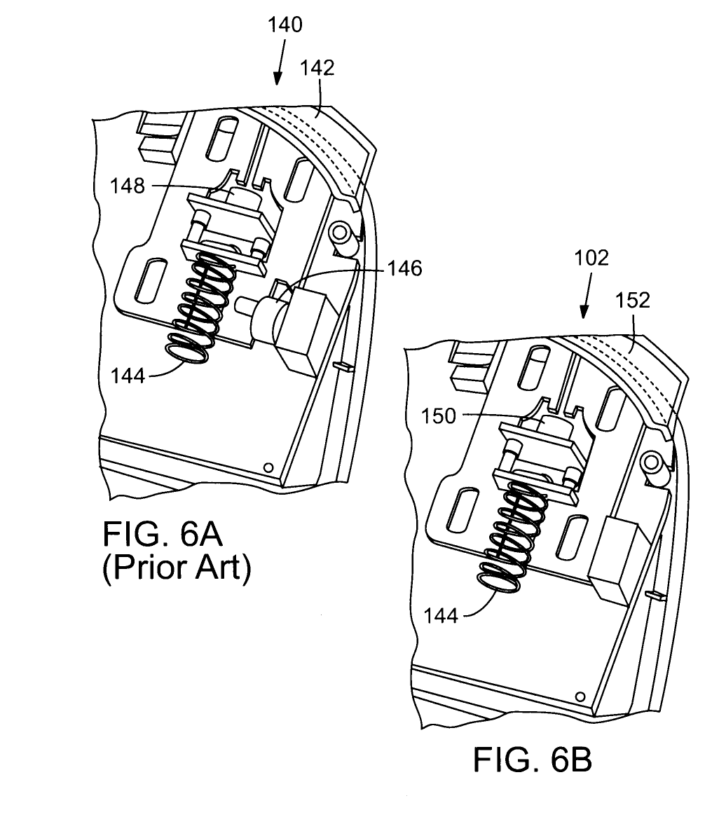

FIG. 6A shows a rendering of a prior art trigger control button assembly 140 of a hand-held game controller. The movement of a push button 142 of trigger control button assembly 140 is tempered by a coil spring 144. Push button 142, when pressed downward, turns a rotary variable resistor (potentiometer) 146 so that the scanning MPU interprets a change in (i.e., lowering of) resistance as variable resistor 146 turns. This resistance change is then converted to digital format, and the MPU can then sense the approximate force being applied. Trigger control button assembly 140 also includes a tack switch 148, which provides a short circuit when push button 142 is pressed down fully. This elimination of resistance indicates to the scanning MPU that maximum force has been applied. The design of trigger control button assembly 140 has certain limitations, which include the use of several moving parts in relation to push button 142 and spring 144 and a low resolution indication to the MPU of user-applied force.

FIG. 6B, in comparison to FIG. 6A, shows an embodiment of pressure-sensing control actuator 102 that is constructed by the removal of rotary variable resistor 146 and tack switch 148 and the placement of a pressure-sensing sensor 150 in the location previously occupied by tack switch 148 of trigger control button assembly 140 of FIG. 6A. Commercially available sensors suitable for implementation as pressure-sensing sensor 150 include a FlexiForce Sensor Model A201 piezoresistive force sensor available from Tekscan, Inc., South Boston, Mass.; and INASTOMER SR.D series rubber molded cover dome type pressure conductive sensor and SR series rubber molded cover pressure conductive sensor, both available from INABA Rubber Co., Ltd., Osaka, Japan. The removal of moving parts provides greater reliability, and the installation of pressure-sensing sensor 150 provides greater resolution than that of variable resistor 146 shown in FIG. 6A. In FIG. 6B, when a push button 152 is pressed downward against pressure-sensing sensor 150, it immediately begins to respond with decreased electrical resistance. In this embodiment, pressure-sensing sensor 150 provides positive tactile feedback to the user's finger when it applies pressure. In addition, pressure-sensing sensor 150 provides a greater range of electrical resistance and resolution to the MPU than does the turning of variable resistor 146, with its moving parts.

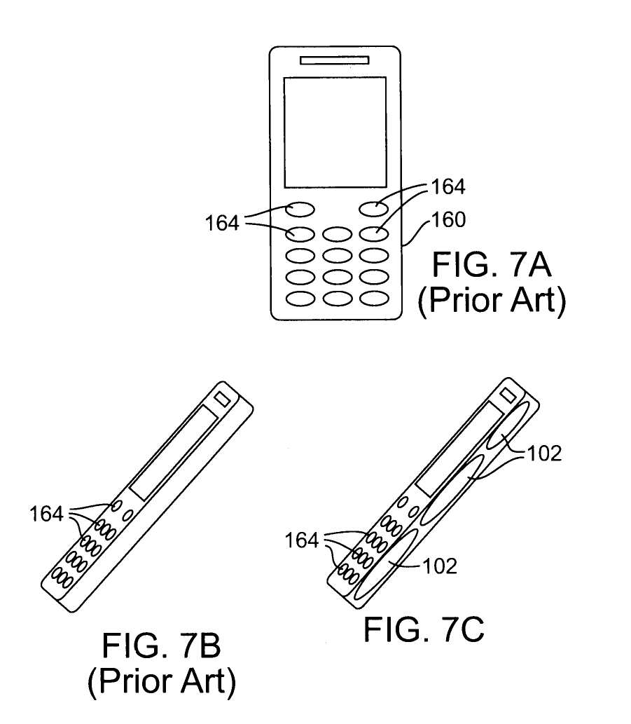

FIGS. 7A, 7B, and 7C show an embodiment of a typical hand-held cellular telephone 160. FIG. 7B shows cellular telephone 160 with conventional side surfaces of the telephone case suitable for gripping. FIG. 7C shows pressure-sensing control actuators 102 built into one or both of the longer side surfaces of the telephone case. Pressure-sensing control actuators 102 allow for user input without requiring the user to depress buttons 164 on the display face of cellular telephone 160. These additional inputs can be preprogrammed to allow, for example, the making of calls, dropping of calls, and changing volume as desired. Again, the example shows the ability to provide user input where only a grip surface was heretofore available.

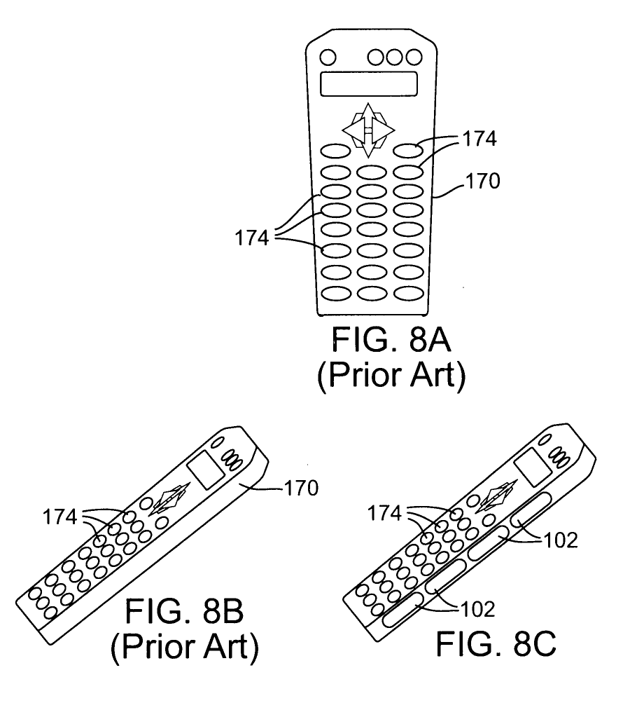

FIGS. 8A, 8B, and 8C show an embodiment of a typical hand-held remote control 170 of a type that would be used to control a television or appliance. FIG. 8A shows the typical array of buttons 174 that are provided on remote control 170. None of the buttons 174 allows for determining a variation in user-applied pressure because they will be only open or closed. FIG. 8B shows the longer side surface of remote control 170 as a typical grip surface. FIG. 8C shows pressure-sensing control actuators 102 built into one or both of the longer side surfaces of the remote control case. Pressure-sensing control actuators 102 can be preprogrammed by operation of the MPU to allow, for example, a capability to change channels without having to press buttons 174 to deliver input numbers, as would normally be done with remote control 170 of FIG. 8A. Pressure-sensing control actuators 102 can be preprogrammed by operation of the MPU to allow for various types of guide activity without requiring a change in the user's grip on remote controller 170 to press buttons 174. The embodiment of FIG. 8C allows for greater user input without requiring repositioning of the user's hands to press buttons 174 on the controller face. Inputs, especially those requiring a range, are conveniently handled with facility by placement of pressure control-sensing actuators 102 in this manner.

The design of the sensor shell areas and placement of the various types of pressure-sensing sensors are shown for illustrative purposes only. Skilled persons will appreciate that the designated shell sensing areas and the type and number of sensors being applied may vary. The disclosed pressure-sensing control actuator implementation and complement to the manual controller is common to all of these embodiments.

It will be obvious to those having skill in the art that many changes may be made to the details of the above-described embodiments without departing from the underlying principles of the invention. The scope of the present invention should, therefore, be determined only by the following claims.

1. In a method of providing control command input to a manual controller including control actuators to produce control command output for manipulating images or symbols on a display, the manual controller having a housing with a surface suitable for a user to grip while manually operating the control actuators, the improvement comprising:
placing in an area of the surface of the housing a pressure-sensing control actuator for control input actuation in response to an amount of user-applied pressure imparting control command input as the user grips by hand the surface of the housing, the pressure-sensing control actuator including a pressure-sensing sensor that provides to the user realistic tactile sensation of control in the manipulation of images or symbols on the display image or symbol action corresponding to the control command output.

2. The method of claim 1, in which the pressure-sensing sensor produces a signal of different values in response to different amounts of user-applied pressure.

3. The method of claim 2, in which the different values are of electrical resistance.

4. The method of claim 1, in which the manual controller includes a grip structure in which the pressure-sensing control actuator is seated and a shell member covering the pressure-sensing control actuator, the shell member being sufficiently flexible to transmit the user-applied pressure to the pressure-sensing control actuator.

5. The method of claim 1, in which the pressure-sensing control actuator is a member of a set of multiple pressure-sensing control actuators placed in the area of the surface of the housing for control input actuation in response to user-applied pressure imparting control command input as the user grips by hand the surface of the housing, the placement of a set of multiple pressure-sensing control actuators in the area resolving the amount of user-applied pressure to an extent corresponding to the number of pressure-sensing control actuators in the set.

6. The method of claim 5, in which the manual controller includes processing circuitry operatively associated with the multiple pressure-sensing control actuators in the set to determine the amount of user-applied pressure.

7. The method of claim 5, in which the manual controller includes a grip structure in which the set of multiple pressure-sensing control actuators is seated and a shell member covering the pressure-sensing control actuators in the set, the shell member being sufficiently flexible to transmit the user-applied pressure to the pressure-sensing control actuators in the set.

8. The method of claim 1, in which the pressure-sensing control actuator is a member of one set of multiple sets of pressure-sensing control actuators placed in different areas of the surface of the housing for control input actuation in response to user-applied pressure imparting control command input as the user grips by hand the surface of the housing, the placement of the multiple sets of pressure-sensing control actuators in the different areas resolving distributed compressive forces contributing to the amount of user-applied pressure to an extent corresponding to the number of pressure-sensing control actuators in the sets.

9. The method of claim 8, in which different ones of the sets include different numbers of the pressure-sensing control actuators.

10. The method of claim 8, in which the manual controller includes processing circuitry operatively associated with the pressure-sensing control actuators in the multiple sets to determine the amount of user-applied pressure.

11. The method of claim 1, in which the manual controller is adapted to control images or symbols on a display screen of a video game system.
